(19) United States
(12) Patent Application Publication
(10) Pub. No.: US 2008/0030737 A1
(43) Pub. Date: Feb. 7, 2008

(54) MULTIPLE PASS SURFACE PLASMON RESONANCE DETECTOR

(75) Inventors: Chin B. Su, College Station, TX (US); Jun Kameoka, Cellege Station, TX (US)

Correspondence Address: SCHWEGMAN, LUNDBERG & WOESSNER, P.A., P.O. BOX 2938, MINNEAPOLIS, MN, 55402, US

(73) Assignee: The Texas A&M University System, a Texas State Agency

(21) Appl. No.: 11/832,554

(22) Filed: Aug. 1, 2007

Related U.S. Application Data
(60) Provisional application No. 60/821,092, filed on Aug. 1, 2006.

(51) Int. Cl. G01N 21/55

(52) U.S. Cl. 356/445

(57) ABSTRACT

A fiber optic multiple-pass surface plasmon resonance technique provides an increase in the number of passes to any arbitrary number is described. Multiple reflections off a reflective sample surface are achieved in one embodiment using a fiber optic collimator, a reflector, and a second reflector, such as a corner cube prism. An electric field assist may be provided by migrating charged molecules to be detected toward the reflective sample surface. In further embodiments, the filed assist may be used with a single pass surface plasmon resonance technique. In still further embodiments, an electo-optic modulated recirculation loop may be used to increase the number of reflections off the sample surface.

### RELATED APPLICATION

This application claims the benefit under 35 U.S.C. 119(e) of U.S. Provisional Application Ser. No. 60/821,092 filed Aug. 1, 2006, which application is incorporated herein by reference.

### BACKGROUND

The discovery and development of effective drugs to treat diseases such as cancer is usually a very time-consuming and costly endeavor. During the process of drug development, researchers often encounter the problem of how to assess the effectiveness of their proteins designed to cause cell apoptosis (orderly programmed cell death). Traditionally, this crucial knowledge can be obtained by first staining the cell, and then by fragmenting their DNA, followed by PARP cleaving and Caspase cleaving which are very time-consuming processes requirement about two days to accomplish. However, these processes are needed because microscopic examination cannot tell the difference between an apoptosis cell and a living cell. Considering that roughly 10,000 drugs are waiting to be tested at any time, it is easy to understand the need and the value of a quick diagnostic method.

Many types of electrical, mechanical, and optical sensors are being developed for biomedical research and diagnostics. Highly sensitive electrical nanowire sensors can detect small amount of biomolecules immobilized on the surface of the silicon nanowires. Nano scale cantilever showed great potential for detection of single virus. Photon-tunneling sensors that integrate nanochannels with total internal reflection sensing elements have also been developed.

The first surface plasmon resonance (SPR) chemical sensor was developed by Kawata et. al in 1988, and since then SPRs has been widely utilized for chemical and biological sensing because of their cost-effectiveness and ease of operations. SPR sensing elements have also been integrated with microfluidic channels for detecting biomolecules. Basically, SPR technique relies on the evanescent optical wave extending just above a very thin metal surface (usually gold) to sense the presence of target substance, especially bio-molecules residing on the gold surface. Because the spatial extent of the evanescent wave above the gold surface is very small, just a monolayer of molecules on the gold surface can significantly affect the evanescent wave. In SPR one detects a change in the gold surface reflectivity caused by the residing molecules.

Generally, SPR is implemented by using the Kretschmann's configuration with a light source and a detector on opposite sides of a prism, which allows for one reflection (one pass) of the optical beam from a gold layer deposited or placed on the prism's hypotenuse.

### BRIEF DESCRIPTION OF THE DRAWINGS

FIG. 1 is a multi-pass surface plasmon resonance (MPSPR) device according to an example embodiment.

FIG. 2 is a part schematic representation of a fiber optic configuration for increasing the number of passes of the device of FIG. 1 according to an example embodiment.

FIG. 3 is a graph illustrating pulse sequences according to an example embodiment.

FIG. 4 is a log plot of reflectivity versus angle for different numbers of passes according to an example embodiment.

FIGS. 5A, 5B, 5C and 5D illustrate various electrode configurations according to an example embodiment.

FIGS. 6A, 6B, 6C and 6D illustrate biochips according to an example embodiment.

FIGS. 7A, 7B and 7C illustrate cell apoptosis in one electrode configuration according to an example embodiment.

FIG. 8 shows the reflectivity signals for the case with and without the present of cytokine in the media according to an example embodiment.

FIG. 9 is a graph illustrating sensitivity according to an example embodiment.

FIG. 10 shows the test results using different concentrations according to an example embodiment.

FIG. 11 illustrates differences in their concentrations according to an example embodiment.

FIG. 12 illustrates a multi-pass SPR device with a grating according to an example embodiment.

FIG. 13 illustrates an SPR device with an all fiber recirculating loop according to an example embodiment.

FIG. 14 illustrates reflectivity versus incident angle profile according to an example embodiment.

FIG. 15 illustrates a differential increase of the pulse-amplitude with number of passes for salt solution over DI water according to an example embodiment.

FIG. 16 is a graph illustrating an SPR program using the transmission matrix method for plane waves according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

In one embodiment, an optical detector includes a light source which directs light toward a reflective sample surface at an angle from incident. An optical corner cube or other type of reflecting device is used to reflect light from the reflective surface, back toward the reflective surface, but slightly offset and substantially parallel to the path of light received from the reflective surface. The light is then reflected by the reflective surface back toward the light source, which has a reflector that reflects the light back along the same path. The light is again reflected back toward the corner cube, and again back toward the light source, which also serves to collect the light that has been reflected four times off the reflective surface.

In one embodiment, the light source and corner cube are positioned on adjacent faces of a prism, such as a right angle prism, with the reflective surface positioned on the hypotenuse of the prism. The light source may be a collimating optical waveguide, such as an optical fiber. A grating may also be used at the light source. In some embodiments, the reflective surface is a plasmon surface formed of reflective metal, such as gold, silver or titanium, or combinations thereof. A sample may be placed on the reflective surface that changes the reflectivity of the surface. Other metals may also be used. In yet a further embodiment, an optical circulator is coupled to the waveguide to increase the number of reflections off the reflective surface. The light source may be coupled to a laser, which may provide pulses of laser light at desired frequencies.

In a further embodiment, an optical detector includes a surface plasmon resonance detector having a plasmon surface with a reflectivity that varies as a function of charged molecules proximate the plasmon surface. A pair of electrodes may be coupled to a power source and serve create an electrical field that moves charged molecules toward the plasmon surface. The plasmon surface may form one of the electrodes, and may be an optically reflective metal. The optical detector may be a multi-pass detector as described above, or a single pass optical detector. The field assisted technique may distinguish between an apoptosis cancer cell and a live cancer cell. This can be very important for anti-cancer drug screening because the effectiveness of the drug can be determined in a few minutes instead of days using prior techniques. The field assisted technique may increase the surface plasmon resonance signal with regard to cell or biomolecule detection, providing an equivalent to biochemical amplification. It may be used for a variety of applications, such as enzyme activity measurements and bacteria count experiments.

In one embodiment, one or more multiple wells may be coupled proximate the plasmon surface for containing fluid proximate portions of the plasmon surface where reflection of the light occurs. The charged molecules within the well or wells migrate toward the plasmon surface in the presence of an electric field. The wells may include a fluid aperture and an insulator creating a channel to the plasmon surface that is offset from the fluid aperture. A fluid aperture opening into a reservoir may also be used, with a detection hole allowing charged molecules to move into a detection chamber proximate the plasmon surface.

A multiple pass surface plasmon resonance detection system is first described in detail. Various embodiments illustrating electrode configurations for providing a field assist are then described, as well as an alternative multiple pass detection system that increases the number of passes that may be obtained. The detection system may be used with the field assist method and structures described following the multiple pass embodiments. The field assist method and structures may be used with multiple pass or single pass systems.

A fiber optic multi-pass SPR technique may enhance the sensitivity or plasmon resonance detection techniques by any arbitrary factor depending on the number of passes through a sample. That multipass SPR improves sensitivity is shown below: Assume that we sit at a bias angle θ₀ below the resonant angle. The detection power is P₁=a·R(θ) for one pass, and is Pₙ=b·Rⁿ(θ) for n pass. For a fair comparison, assume the bias power for the n-pass matches the 1-pass; ie, aR(θ₀)=bRⁿ(θ₀)=P₀.

Taking derivatives with respect to θ, one have for the 1 and n-pass,

$$\frac{ⅆ {P}_{1}}{ⅆ θ} = {P}_{0} \{ \frac{1}{R ( {θ}_{0} )} \cdot \frac{ⅆ R}{ⅆ θ} \}$$

$$\frac{ⅆ {P}_{n}}{ⅆ θ} = n \cdot {P}_{0} \{ \frac{1}{R ( {θ}_{0} )} \cdot \frac{ⅆ R}{ⅆ θ} \} = n \cdot \frac{ⅆ {P}_{1}}{ⅆ θ}$$

Thus at any bias level, dPₙ/dθ is intrinsically greater than dP₁/dθ by a factor n, the number of pass.

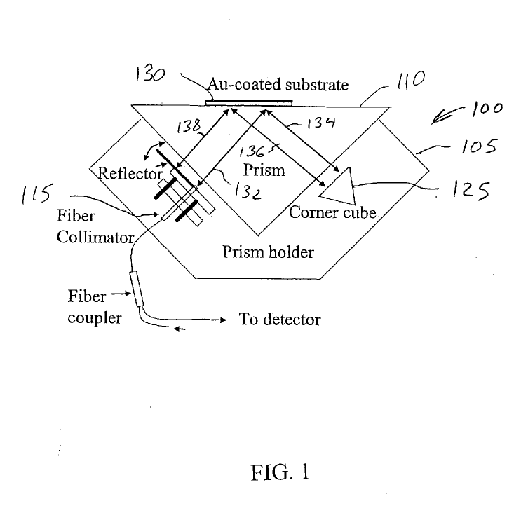

The discussion described above illustrates the effectiveness of a multi-pass SPR device. One embodiment of a multi-pass SPR device is shown at 100 in FIG. 1. Several components are mounted on a prism holder 105 as shown. They are the prism 110, the fiber optic collimator/reflector unit 115, and a corner cube prism 125. The fiber optic collimator and reflector 115 are fixed in one unit and they rotate in unison in one embodiment. A gold-plated substrate target 130 is placed on the prism surface. The collimator 115 delivers an optical beam 132 to the substrate. The optical beam propagates at 134 toward the corner cube following a reflection from the substrate's gold surface. The backward reflected beam 136 off the corner cube may be substantially parallel (such as within 2 arc-second) to the incident beam 134. This beam 136 hits the gold surface 130 the second time and proceeds towards the reflector at 138. The normal of the reflector is engineered substantially parallel to the beam emanating from the fiber collimator, ensuring that the backward reflected light from the reflector retraces the previous light path, eventually returning the beam back into the collimator 115 after impinging the gold surface four times. The provision that the return light signal propagates back into the collimator fiber waveguide allows for easy detection and signal processing using standard fiber optic techniques. The whole unit may be compact and portable.

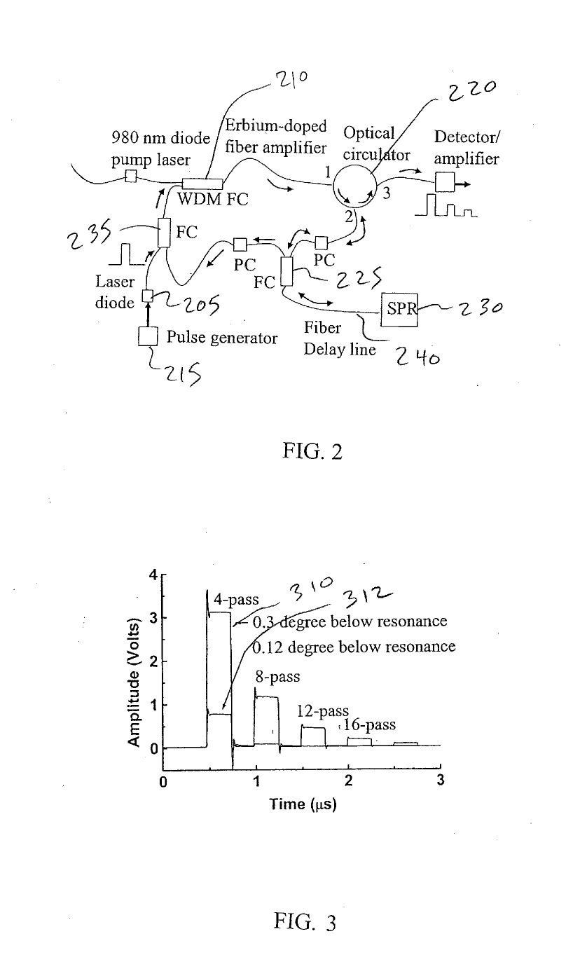

Pulse operation of the laser light may be used to increase the number of passes beyond 4. In one embodiment, a fiber optic configuration external and independent of the aforementioned SPR device is illustrated at 200 in FIG. 2. Configuration 200 uses a light wavelength of 1.53 μm from a laser diode 205 for convenience because an erbium-doped fiber amplifier (EDFA) 210 for signal amplification is readily available commercially. Other wavelengths may be used in different embodiments. The initial input optical pulse driven by a pulse generator 215 enters the EDFA 210. The pulse travels down an optical circulator 220 and into an optical splitter 225 and into the SPR device 230. The return pulse from the SPR, which has already taken 4 passes through the gold surface, is routed into the same EDFA 210 through a fiber splitter 235. After the pulse re-emerges from the SPR device it has taken another 4 passes through the gold surface, hence the total number of passes has increased to 8. The process continues indefinitely, thus, theoretically, the number of passes can extend to infinity. A fiber delay line 240 temporally separates the individual pulses. Polarization controllers 245 and 250 may be adjusted so that all pulses entering the SPR 230 are TM polarized. The re-circulating pulse sequence is shown in FIG. 3 for the case of 0.30 below resonance at 310 and 0.12° below resonance at 312. The reduction in amplitude of subsequent pulses is due to the extra optical loss experienced by the pulse after traversing a round-trip through the optical system.

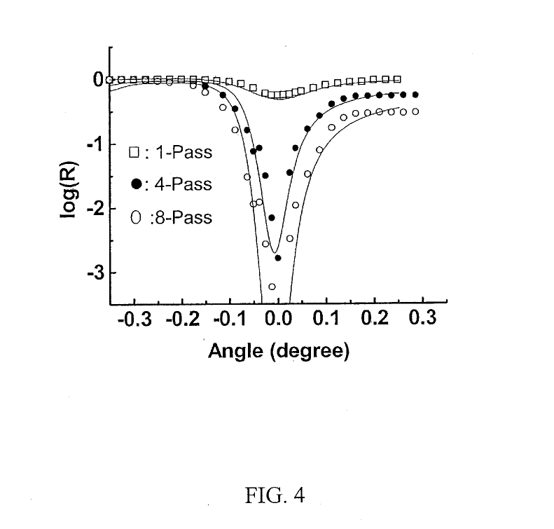

Experimentally, the collimator-reflector may be angle-scanned through the SPR resonance. A log plot of the reflectivity versus angle is shown by symbols in FIG. 4 for the case of 1, 4, and 8-pass through the gold surface. For the 1-pass measurement the corner cube was removed and replaced with a detector. It is noted that the measured minimum reflectivities are about 0.5 and 0.13×10⁻² for the case of 1 and 4 pass. For the 8-pass, the power level at minimum reflectivity is below the detectable limit (0.04 mV). In order to fit the experimental results to calculated profile, the collimator's beam divergent angle may be taken into account, since the reflectivity dip is very sharp. The divergent angle φ for the collimator used is 0.2° (FWHM). The measured resonance profile R(θ) is given by,
R(θ)=∫H(θ−θ′)·R_{cal}(θ′)dθ′
Where R_{cal}(θ) is the calculated resonance response and H(θ) is the transfer function describing the effect of the divergent beam. We assume that H(θ) is given by a Gaussian function with

$$H ( θ ) = {( \sqrt{2 π} \cdot σ )}^{- 1} \cdot exp ( \frac{- {θ}^{2}}{2 \cdot {σ}^{2}} ) .$$

The width parameter σ is given by σ=(φ/2)(1/1.5)(1/\sqrt{2 ln(2)}) for one pass and σ=(φ/2)(1/1.5)(1/\sqrt{2 ln(2)})(α)^{1/2}, for a multiple pass in which the beam returns back to the collimator. The factor 1.5 accounts for the reduction in beam divergence upon entering the prism due to Snell's law, and the factor α accounts for the reduction of beam divergent effect on R(θ) due to the increased beam diameter when the beam returns to the collimator after encountering 4-passes through the sample. In fact, α is equal to the coupling efficiency back into the collimator, which is measured to be 10%. For 1-pass α=1, and for multiple-pass α=0.1. Parameters used in the calculation are: Gold layer thickness was 45 nm. Refractive indices of BK-7 and Au at 1530 nm wavelength⁹ were 1.50065 and 0.4+9.7i respectively. φ=0.2°, and α=0.1 or 1 for multiple pass or 1-pass respectively. The 4-pass and 8-pass results were described by R⁴(θ) and R⁸(θ) correspondingly. Calculated R_{cal}(θ) was for air interface which was the case in this experiment. These parameters are for example purposes only, and many may be varied significantly in further embodiments.

Lines are calculated results using parameters described above. Calculated and measured values agree reasonably well. The minimum reflectivity for the 4-pass case is 1.3×10⁻³. The minimum reflectivity (1.7×10⁻⁶) for the 8-pass case is not displayed because its value is below our detectable limit. It is noted that the collimator's beam divergent angle φ of 0.2° does have a significant effect on the reflectivity. For instance, if (φ=0 instead of 0.2° then R is 0.12 instead of 0.47 for the 1-pass case.

It is known that the extent of the evanescent wave is longer for longer wavelengths. However, the choice of 1530 nm is not generic to this technique. Shorter wavelength, such as 670 nm for example may also be used. In any case, the intrinsic sensitivity at 1530 and 670 nm wavelength may actually be similar because the resonance is much sharper at 1530 nm wavelength, although the angle shift is much larger at 670 nm: If the gold surface is perturbed by a 1 nm thick material with refractive index of 1.45, calculations indicate that at 670 mm the resonant angle shift is 0.093°/nm, and is 0.0130/nm at 1530 nm. However, the resonant half width at 670 and 1530 nm are 0.35° and 0.04° respectively. Thus, if one sits at a bias angle and measure the reflectivity change, the intrinsic sensitivity is roughly the same for both wavelengths. The number of passes will determine the improvement. If the choice of wavelength is 1530 nm, which is the wavelength used for this demonstration, the appropriate sensing measurement would be to sit at a fixed bias angle and measure the reflectivity change.

Note that a 30 nm gold thickness can yield a smaller reflectivity, but the resonance is also wider.

In one embodiment, the smallest reflectivity is 0.1% for the 4-pass case. Biasing the device at the low reflectivity with multiple passes offers the potential for the largest percentage change in power. This SPR device is compact, portable, and should have high detection sensitivity. A fiber optic scheme to increase the number of pass to any arbitrary number is also given.

Further details of alternative multipass embodiments are now described. While references to the plasmon surface being gold are used, it is understood that other reflective metals may also be used. Further, while a corner cube is described, other reflectors that receive and reflect a beam of light slightly displaced but substantially parallel to each other may be used. In still further embodiments, different structures may be used to reflect light off a plasmon surface multiple times prior to detection of the intensity of the light.

The discovery and development of effective drugs to treat diseases such as cancer is usually a very time-consuming and costly endeavor. During the process of drug development, researchers often encounter the problem of how to assess the effectiveness of their proteins designed to cause cell apoptosis (orderly programmed cell death). Traditionally, this crucial knowledge can be obtained by first staining the cell, and then by fragmenting their DNA, followed by PARP cleaving and Caspase cleaving which are very time-consuming processes requiring about 2 days to accomplish. However, these processes are needed because microscopic examination cannot tell the difference between an apoptosis cell and a living cell. Considering the roughly 10,000 drugs waiting to be tested at any time, there is a need for a quick diagnostic method.

In one embodiment a field assisted surface plasmon resonance technique (FASPR) may be used to determine, within a matter of minutes, the survival status of a cancer cell that is subjected to a cytokine protein designed to cause cell apoptosis. Using the disclosed technique, a feasibility test on a certain type of cancer cell has been conducted and found to be very effective in assessing the survival status of the cell. Field assisted surface plasmon resonance is effective because many biological processes such as cell apoptosis, enzyme activity, virus-cell interaction, and bacteria dissociation all involve charge biomolecules. These charge biomolecules can easily and quickly be detected by the disclosed FASPR technique. FASPR should provide biomedical researchers and pharmaceutical companies a new method to quickly detect very low concentration of targeted biomolecules. The contribution of this device to biomedical research and drug discovery should be enormous.

In one embodiment, a field-assist SPR technique (FASPR) that, in addition to MSPR, can detect charge biomolecules, thus significantly expanding the application of MSPR. FASPR can be widely applied to detect many types of biomolecules. The combined device may be referred to as a multipass field-assisted surface plasmon (MPFASPR). However, a single pass SPR used with the field-assisted method may also be used. In addition to the ability to detect cancer cell apoptosis, FASPR may have the sensitivity to detect some charge molecules with concentration in the pico-molar (pM) range. This device offers great promises in outperforming traditional methods in terms of detection sensitivity, speed and costs, and can potentially be used in a wide range of biomedical applications, particularly in the area of drug screening.

Multipass Field-Assisted Surface Plasmon Resonance (MFASPR)

As a general description, a drop of liquid solution with charge biomolecules floating in the solution is dispensed onto the SPR gold surface. In one embodiment, the charged molecules floating in the solution are moved to the SPR gold surface by the application of an electric field. Silver or other types of metal surfaces may also be used in further embodiments. The accumulated (amplify) molecular concentration at the metal surface perturbs the surface plasmon mode that exists at the metal-solution interface. This perturbation of the surface plasmon is manifested as a change in the reflected optical power. When coupled with the multiple pass surface plasmon resonance detection device, sensitivity may be significantly enhanced.

Electrodes Configurations

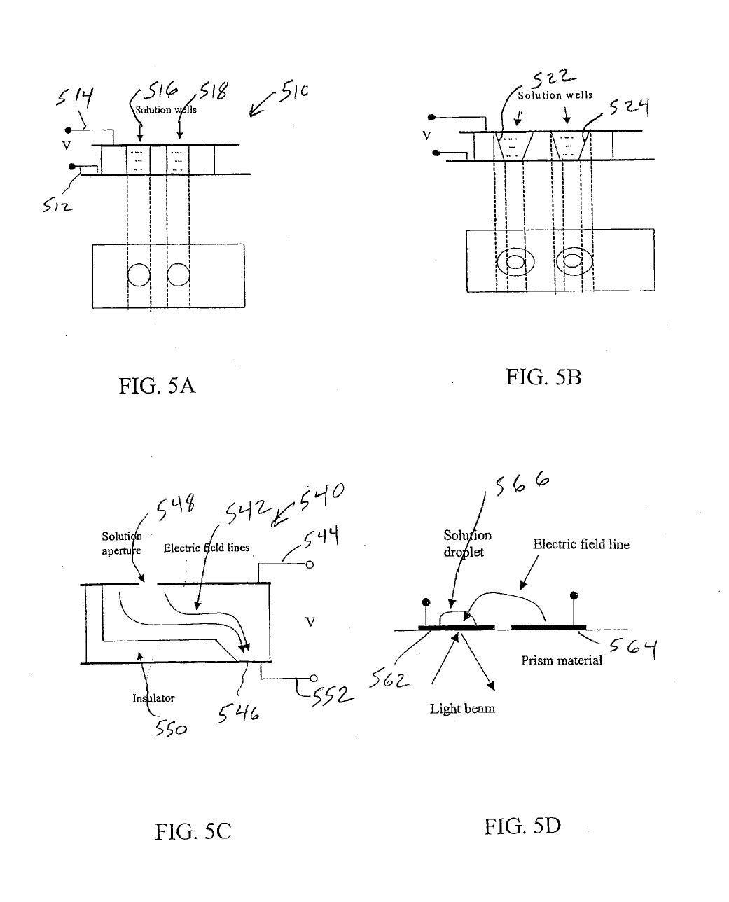

FIGS. 5A, 5B, 5C and 5D are side and top views of various types of electrode configurations that may be used in one embodiment. Other electrode configurations are also possible. Electrode configuration 510 in FIG. 5A has a perpendicular geometry that has the SPR gold surface as one electrode 512. The other electrode 514 is placed directly on top of the SPR electrode with an insulator material with two straight holes 516, 518 as solution wells sandwich between the two electrodes.

Electrode configuration 520 in FIG. 5B has wells 522 and 524 that are tapered toward the SPR surface in order to gather more particles towards the laser spots. Electrode configuration 540 in FIG. 5C illustrates an electric field 542 that curves sideways from the top electrode 544 to the position of a laser spot 546. The solution is dropped into solution aperture 548 of the top electrode, anode 544. Gravity forces the uncharged molecules directly down to an insulator 550 without perturbing the SPR signal. The electric field moves the charged molecules to the laser spot for detection. A cathode 552 is positioned proximate the detection area 546. Electrode structure 540 offers the effect of filtering the unwanted uncharged molecules, and is particularly effective for large molecules such as cells.

Electrode configuration 560 in FIG. 5D is a coplanar structure in which the SPR gold surface is divided into two electrically isolated sections 562 and 564 with the two sections functioning as the two electrodes. The solution is merely dropped on one of the electrodes as illustrated at 566.

Biochip Configurations

Electrode configuration 540 may be used for cell measurements and its fabrication is described in detail below:

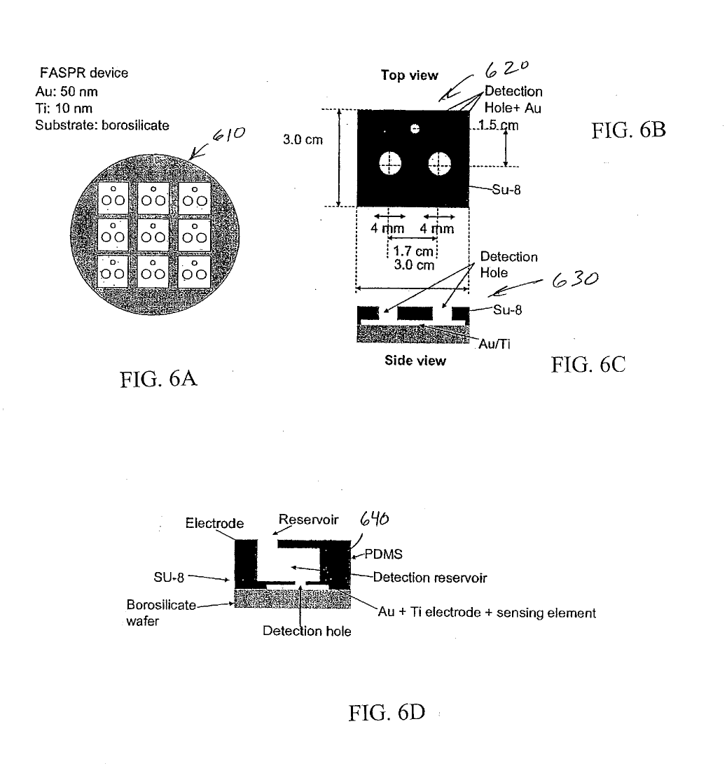

Electrode configuration 540 may be fabricated by lithography and metal evaporation on a borosilicate wafer. This device configuration may significantly improve the detection error and the minimum detection limit. In addition, due to an array fabrication process, the cost for the fabrication of an individual biochip may be significantly decreased An array design of the biochip is indicated at 610 in FIG. 6A. The fabrication process of this biochip is as follows. Ti/Au electrodes were created by the standard lift-off process (deposition of metals on the lithographically patterned photoresist.). Then, a detection hole is lithographically patterned on SU-8 layer. The top view 620 in FIG. 6B and side view 630 in FIG. 6C of this electrode configurations are shown. At a final step, a PDMS cover part 640 is fabricated from the mold and positioned on the top of the detection hole as shown in FIG. 6D.

Operation of Biochip for the Detection of Cell Apoptosis

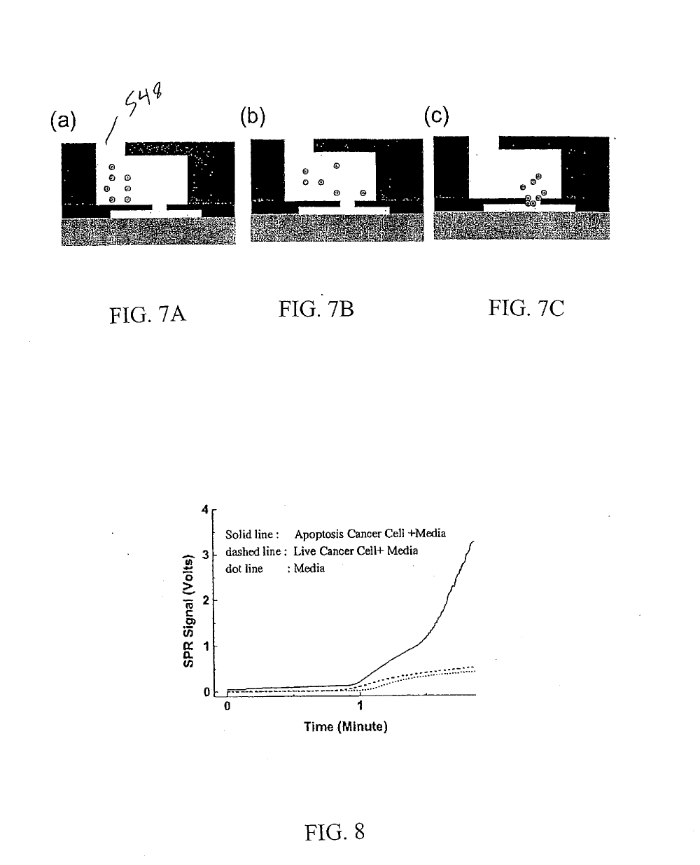

In one example embodiment, buffer solution is filled in the detection reservoir and the sample cells are infused into this reservoir in FIG. 7A. Then, a potential is applied between two electrodes in which one is positioned at the entrance of the reservoir 548 and the other one is at the bottom of the detection hole 546. If the cells are not in the apoptosis stage, they are suspended in the solution as illustrated in FIG. 7B. However, in case of cell apoptosis, they are attracted to the cathode 552 as illustrated in FIG. 7C. The advantage of this approach is the reduction of error and the smaller detection volume that increase the sensitivity. Because the suspended cells are not directly guided by the electric field into the detection hole but merely float downward by gravity, the error count will be significantly decreased. In addition, the detection area is significantly reduced, improving the sensitivity and the minimum detection limit.

Cell Apoptosis Applications

Measurements may be made on cancerous lymphocyte in a media solution. In one representative example, Cytokine proteins were introduced into the solution to cause cell apoptosis. Droplets of solution with and without cytokine were alternatively injected onto the gold surface for comparison of their time-dependent reflectivity signals when a voltage is applied across the electrodes. At time t=0, a voltage of 2 volt was applied across the electrodes to draw the apoptosis cells or live cells to collect at the SPR surface. FIG. 8 shows the reflectivity signals for the case with and without the present of cytokine in the media. The reflectivity signal for the media alone is also shown.

The data show that apoptosis cancer cells in the solution creates a much bigger signal compare with the media solution with live cancer cells. It is observed that one can distinguish between an apoptosis and non-apoptosis cell in just two minutes. This is a very significant result for drug screening purposes.

Bacteria Concentration Measurements

The SPR technique may also be used determine bacteria concentrations in a solution. Bacteria can be fragmented by ultrasonic shaking in a solution bath. The ions in the bacteria spill into the solution upon fragmentation. The charge ions may be measured by the present technique. The signal magnitude may be used to measure the ion concentration, which is proportional to the bacteria concentration. In one embodiment, the measurement may be performed using electrode configuration 540 in FIG. 5C. The fragmented pieces will settle at the insulator surface 550 so as not to contribute to the SPR signal, while the ions will be attracted to the SPR surface at 546.

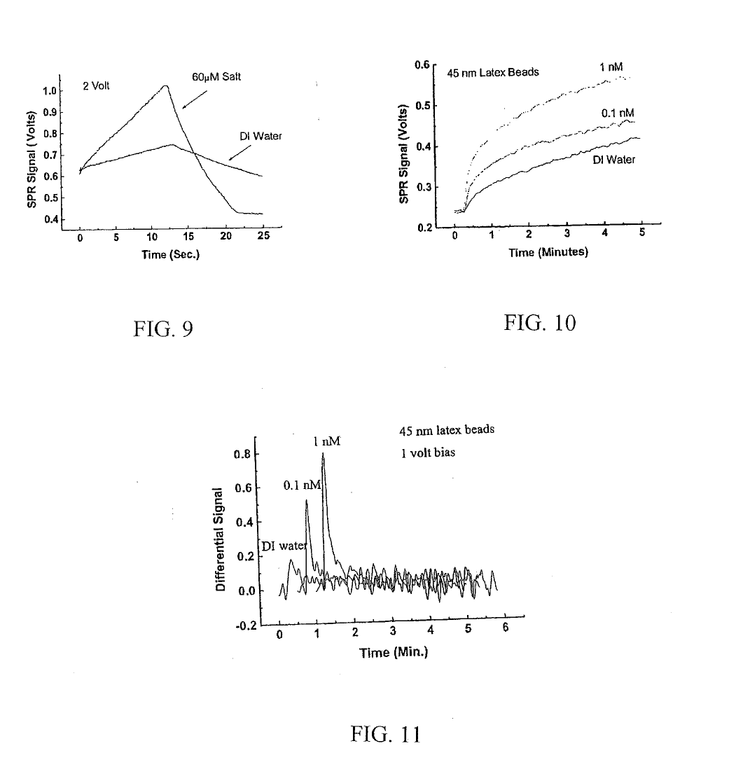

A test of the sensitivity of this technique may be performed using a salt solution. At time t=0, a voltage of 2 volt is applied across the electrodes to draw the negatively charged salt ions (chlorine ion in this case) to collect at the SPR surface. The data is shown in FIG. 9.

The size of an ion is a fraction of a nanometer. The size of proteins is about 5-10 nm, while the size of cells are about 10 to 100 m. In general, for nanometer size molecules SPR is more sensitive for larger molecules. A test with 45 nm size latex beads in DI water may be conducted for the evaluation of the SPR signal with respect to the particle concentration.

FIG. 10 shows the test results using 0.1 and 1 nM (nanomole/liter) concentration of 45 nm diameter latex beads in DI water. The results are compared with pure DI water.

During the first 2.5 minutes (FIG. 3), one applied a voltage across the electrode such that negatively charge latex beads are driven to the gold surface. The SPR signal increases with a time. The signal increase due to the present of latex beads is apparent. This result indicates that for particle size of about 50 nm, the detectable concentration is in the pico-molar range. By taking the time-derivative of the signal, the differences in their concentrations are made more apparent. This is shown in FIG. 11. This technique can be used for determining the concentration of molecules.

Many types of voltage sequences will allow the determination of molecular size and charge if the solution contains various types of molecules. For instance, a reverse voltage may be applied to drive all negatively charge particles to a “starting line” above the SPR surface. The molecules would then “race” down to the SPR surface upon the application of a positive voltage. The time-profile of the signal should provide rich information regarding the molecular constituents in the solution.

Further details of the use of an electric field to concentrate charged molecules proximate or on a plasmon surface in either a single pass or multiple pass detection system are now described.

Instruments for detecting the presence of very small quantities of life threatening biosubstances are important for homeland security, biochemical research as well as medical diagnostics. Sensitive techniques for immunoassays analysis and the ability to sense small amounts of chemicals in solutions or in the air environment are needed in the medical industry.

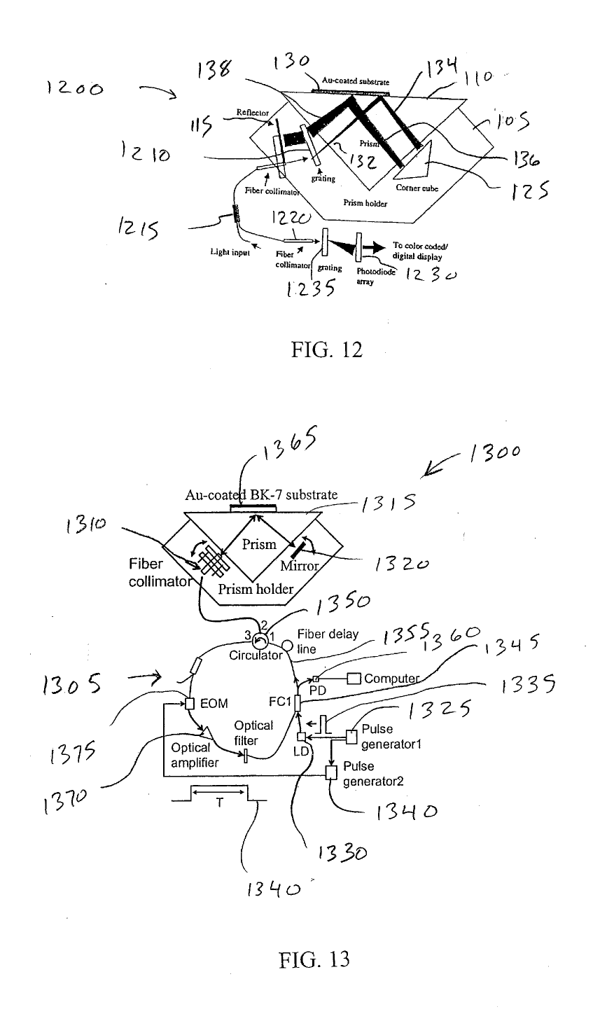

In one embodiment, a multi-pass SPR device 1200 similar to that shown in FIG. 1, further includes a grating 1210 that not only increases the sensitivity, but also allows for wavelength scanning, which may be more desirable from a practical and economical standpoint, compared with angle scanning. The numbering of FIG. 1 is consistent with that of FIG. 12.

Several components are mounted on a prism holder 105 as shown. They are the right-angle prism 110, the fiber optic collimator-reflector unit 115, and a corner cube prism 125. The fiber optic collimator and reflector 115 are fixed in position in the unit and have the provision to rotate both the collimator and reflector in unison. The gold-plated substrate target 130 is placed on the prism 110 surface. The collimator 115 delivers an optical beam to the substrate. The optical beam propagates toward the corner cube 125 after reflection from the substrate's gold surface. The backward reflected beam off the corner cube is exactly parallel (within 2 arc-second) to the incident beam due to the intrinsic function of the corner cube. This beam hits the gold surface the second time and proceeds towards the reflector. The normal of the reflector is engineered to be exactly parallel to the beam emanating from the fiber collimator, guaranteeing that the backward reflected light from the reflector exactly retrace the previous light path, eventually returning the beam back into the collimator after impinging the gold surface 4 times. The provision that the return light signal propagates back into the collimator fiber waveguide allows for easy detection and signal processing using standard fiber optic techniques and components readily available commercially. The whole device is compact and portable unlike the traditional Kretschmann's geometry which basically has the light source on one side and the detector on the other side (in the position of the corner cube), striking the substrate only once.

Light is injected into the SPR device via a fiber coupler 1215 and collecting light returning from the SPR device is provided to a fiber collimator 1220. It is noted that any wavelength of light can be used, although convenient wavelengths are around 0.8, 1.3, and 1.5 μm due to their commercial availability.

This application uses a light wavelength of 1.55 μm for convenience because erbium-doped fiber amplifier (EDFA) for signal amplification is readily available commercially, although other wavelengths can also be used. Use of semiconductor optical amplifier instead of fiber amplifier can also be used. If a light source with sufficient power is used, then no amplifier is necessary. In fact, semiconductor lasers with more than 100 mW of output power are readily available.

It is noted that the resonance dip is much sharper for multiple passes compare with the traditional one pass method. A shift of the resonance profile to another angle will indicate the presence of chemical or biomaterial on the gold surface. One can use the shift in resonance angle or the change in optical intensity at a fixed angle as a measure of the presence of bio-molecules.

The grating 1210 is appropriately placed between the collimator unit 115 and the prism face. The grating 1210 shown is a transmission grating, although a reflection grating can be used as well.

Again, the light returns to the collimator after every 4-passes. The grating's wavelength dispersion effect further enhances the detection sensitivity. In this application the light source may be a broadband light source (commercially available) in contrast with the previous application in which the light source can, but does not have to be a broadband source. The dispersive light path due to the grating is shown. Since the light path is a function of wavelength, the resonance occurs at a specific wavelength. Thus, in this application, one employ a wavelength scan rather than angle scans, which, in addition to enhanced sensitivity, also offers more convenient and faster scanning speed. Because of the wavelength dispersive nature of the return signal from the SPR device shown, it is not necessary to scan the wavelength at all. One merely substitutes the scanning spectrometer with a photodetector or photodiode array 1230, allowing for a color-coded visual or digital display. A grating 1235 may also be included before the array.

A novel scheme for implementing a 4-pass Surface Plasmon Resonance Biosensor (SPR) that offers high detection sensitivity, compactness and portability is disclosed. A fiber optic scheme to increase the number of pass to any arbitrary number, thereby increasing the detection sensitivity even further, is also disclosed. Both angle scanned and wavelength scanned, and no scanned design are given. This invention offers a method to detect extremely small amount of bio-substances existing in the environment or as a sensitive technique for biochemical analysis. This disclosure uses fiber optic components to demonstrate the function of our SPR device. However, using bulk optical components will work as well. Likewise the use of wavelengths other than the one used here may be used in further embodiments.

In further embodiments, a reflector may be used in place of a corner cube or other type of reflecting device. A simple reflector provides for two passes of light off the plasmon surface. Multiple collimators may also be used, and may be placed in an array as shown in the following pages. The multiple collimators may be aligned with multiple wells, which may also be in a corresponding array formation. In one embodiment, each collimator may utilize two of the wells in the array where a corner cube type reflector provides four or more passes, or there may be a one to one correspondence of collimators to wells where a two pass system is used.

44 Pass Embodiment

A forty four passes fiber optic surface plasmon resonance (SPR) sensor that enhances detection sensitivity according to the number of pass is demonstrated for the first time. The technique employs a fiber optic recirculation loop that increases the number of light wave passing through the detection spot up to 44 times. As a result, the sensitivity of SPR may be improved by a factor of up to 44. Presently, the total number of pass may be limited by the onset of lasing action of the recirculation loop. This technique offers significant sensitivity improvement for various types of plasmon resonance sensor.

FIG. 13 at 1300 illustrates a SPR setup with an all-fiber recirculating loop 1305. The SPR setup comprises a fiber optic collimator 1310 on one side of the prism 1315 and a mirror reflector 1320 on the other side that reflects the beam back into the fiber collimator 1310, resulting in a stand-alone 2-pass configuration that has lower optical coupling loss than the 4-pass configuration. The lower loss may ease the burden on the optical amplifier.

The principle of the forty four pass operation is described below. A first pulse generator 1325 drives a diode laser (LD) 1330 to produce an optical pulse train 1335 with about 5% duty cycle. A second pulse generator 1340 is gated by this pulse train 1335 to produce a synchronized pulse train 1340 with a much longer pulse width T as shown, the function of which will be described later. The optical pulse is split into two pulses by fiber coupler FC1 at 1345. One pulse propagates towards port 1 of a circulator 1350 after traversing a polarization controller, PC3, and a fiber delay line 1355. The other split pulse and subsequent recirculated pulses are detected by a detector/amplifier module 1360. The optical pulse train proceeds towards the SPR setup by exiting port 2 of the optical circulator 1350.

The fiber collimator 1310 collimates the laser beam that impinges on the gold-coated substrate 1365. The beam reflected off the gold-coated substrate is reflected back to the fiber collimator by the mirror, retracing the original optical path. Thus, the SPR setup itself is a two-pass device. The pulse that is reduced in amplitude due to resonance effect and the back coupling loss at the collimator re-enter the fiber loop via port 3 of the optical circulator 1350. The pulse is amplified and restored to the initial amplitude by the erbium-doped fiber amplifier 1370 after passing through the electro-optic modulator (EOM) 1375. The pulse eventually reaches FC1 1335 to complete one round-trip.

The EOM 1375 functions as a loss-modulating optical switch. The switch is closed (low loss) when the gated electrical pulse 1340 is applied to an RF port of the EOM is on, otherwise the switch is opened (high loss). The time duration of the gated pulse determines the number of passes of the SPR system. The switching action helps prevent lasing. The fiber loop with the optical amplifier comprises a fiber laser that can lase without any input, thus, destroying the function of the SPR. The periodic opening of the EOM switch prevents lasing from occurring, but, as a compromise, limits the maximum number of achievable passes. Appropriate adjustment of three polarization controllers, PC1,PC2,PC3 ensures that the same optical polarization is maintained for every round-trip of the recirculating pulse, and the polarization is p-polarized at the SPR for exciting the surface plasmon.

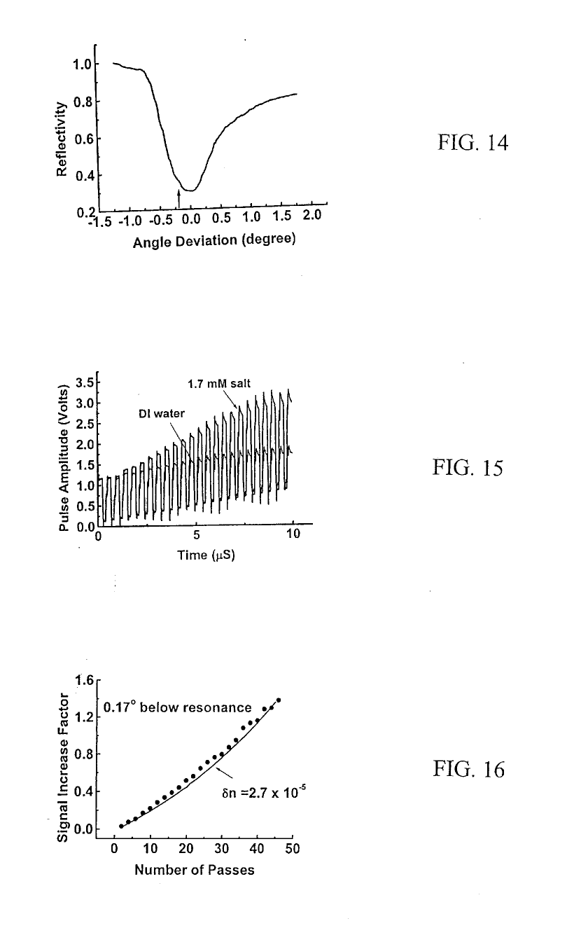

The basic SPR function may be verified by measuring its one-pass characteristics by disconnecting the recirculation loop and by temporarily replacing the reflecting mirror on the SPR setup by a photodetector. The reflectivity versus incident angle profile is shown in FIG. 14, when DI water is dispensed onto the gold surface. One obtained the familiar SPR curve with a minimum reflectivity at resonance occurring at about 62.6 degree incident angle (internal angle in prism). Our diode laser wavelength is 1.53 μm, compatible with erbium-doped fiber amplifier technology. At 1.53 μm wavelength, the resonance profile is sharper and the reflectivity dip is shallower than the response at 0.78 μm which can be verified by simulation.

For multipass applications the collimator and the mirror may be rotated to set the bias point at 0.17° (±0.02) below resonance, as indicated by the arrow in FIG. 14. The multipass experiment may be performed with DI water (18 MΩ-cm quality) by dispensing it on the gold surface, and then the water is replaced with a 0.01% salt/cc (1.7 millimolar) salt solution. The presence of salt increases the solution's index and, according to SPR theory, shifts the resonance angle to slightly larger angle, causing an increase in the reflectivity and optical signal when the bias angle is set below the resonance angle (0.17°). The multipass pulse-train were measured for both cases, and are superimposed FIG. 15. The total number of pulses is 22 and the corresponding number of passes is 44, as each round-trip of the pulse though the loop impinges the gold surface twice. FIG. 15 reveals the differential increase of the pulse-amplitude with number of passes for salt solution over DI water. This result demonstrates the higher sensitivity for more passes. The increase in magnitude of the base-line with time, as observed in FIG. 15, may be due to the temporal increase in amplified spontaneous emission that ultimately will lead to self-lasing within the loop if the gated pulse is too long.

From FIG. 15, the signal increase factor may be calculated as, (Pₛ^{m}−P_{w}ⁿ)/P_{w}^{m}, where Pₛ^{m} and P_{w}^{m} are measured peak amplitudes of the m^{th} pulse for salt solution and DI water respectively. The quantity Pₛ^{m}−P_{w}^{m})/P_{w}^{m} is plotted in FIG. 16 as solid circles. An SPR program using the transmission matrix method for plane waves is used to confirm as shown in FIG. 16. The quantity calculated and plotted (solid line) in FIG. 4 is (Rₛ^{m}−R_{w}^{m})/R_{w}^{m}, where R is the reflectivity of the SPR surface. Parameters used in the calculation are bias angle (0.17°), water index (1.3159), BK-7 index, the gold layer thickness (50 nm), titanium adhesion layer thickness (10 nm) and their dielectric constants, which can be found in reference 9 and 12. The index increase δn of the salt solution is the varying parameter. δn=2.7×10⁻⁵ gives the best fit to the measured data, which agrees fairly well with the predicated δn=2.3×10⁻⁵ for a salt concentration of 1.7 mM.

In conclusion, a 44-pass all-fiber-optic technique for surface plasmon resonance (SPR) sensor enhances detection sensitivity according to the number of pass is demonstrated for the first time. The technique employs a fiber optic recirculation loop that passes the detection spot 44 times thus enhancing sensitivity by a factor of 44. A gated switch is used to turn off the fiber loop to suppress lasing effects. This technique offers significant sensitivity improvements over traditional one-pass plasmon resonance sensor.

Presently, the total number of pass is limited by the onset of lasing action of the recirculation loop. An obvious method to significantly increase the number of pass beyond what has been achieve here is to shorten the optical pulse to accommodate more pulses within the time duration before amplified spontaneous emission becomes too serious. The corresponding detection bandwidth should be increased.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. An optical detector comprising:
a light source;
a reflective sample surface positioned to receive light from the light source at an angle from incident;
a reflector positioned to receive light reflected from the reflective surface and redirect the received light back toward the reflective surface, such that light is reflected multiple times by the reflective surface prior to detection of the light.

2. The optical detector of claim 1 and further comprising an optical recirculating loop.

3. The optical detector of claim 2 wherein the optical recirculating loop comprises an electro-optic modulator that determines the number of loops for light to be reflected.

4. The optical detector of claim 3 wherein light is reflected off the sample surface up to 44 times.

5. An optical detector comprising:
a light source;
a reflective sample surface positioned to receive light from the light source at an angle from incident;
an optical corner cube positioned to receive light reflected from the reflective surface and redirect the received light back toward the reflective surface;
a reflector positioned proximate the light source for reflecting the redirected light from the reflective surface back to the reflective surface, such that the redirected light is received by the corner cube, redirected back to the reflective surface and toward the light source for detection.

6. The optical detector of claim 5 wherein the light source comprises a collimating optical waveguide.

7. The optical detector of claim 6 wherein the optical waveguide receives the reflected light that has been reflected by the reflective surface at least four times.

8. The optical detector of claim 5 wherein the reflective surface comprises gold.

9. The optical detector of claim 8 wherein the gold reflective surface has a reflectivity that varies with substances on the gold reflective surface.

10. The optical detector of claim 5 wherein the reflective surface comprises silver.

11. The optical detector of claim 6 and further comprising an optical circulator coupled to the waveguide to increase the number of reflections off the reflective surface.

12. The optical detector of claim 11 wherein the light source further comprises a laser capable of emitting pulses of light at a desired wavelength.

13. The optical detector of claim 5 and where the light source further comprises a grating.

14. The optical detector of claim 5 and further comprising an optical recirculating loop.

15. The optical detector of claim 5 wherein the optical recirculating loop includes a modulator that controls the number of circulations of pulses in the loop and hence the number of passes.

16. An optical detector comprising:
a collimating optical fiber light source;
a prism having a first face that receives light from the light source;
a reflective sample surface positioned on a second face of the prism to receive light from the light source;
an optical corner cube positioned to receive light exiting a third face of the prism that is reflected from the reflective surface and redirect the received light back toward the reflective surface; and
a reflector positioned proximate the light source for reflecting the redirected light from the reflective surface back to the reflective surface, such that the redirected light is received by the corner cube, redirected back to the reflective surface and toward a light detector proximate the light source.

17. An optical detector comprising:
a surface plasmon resonance detector having a plasmon surface with a reflectivity that varies as a function of charged molecules proximate the plasmon surface; and
an electrode for coupling to a power source and the plasmon surface for moving charged molecules toward the plasmon surface.

18. The optical detector of claim 17 wherein the plasmon surface comprises an optically reflective metal.

19. The optical detector of claim 17 and further comprising means for reflecting light multiple times off the plasmon surface.

20. The optical detector of claim 19 and further comprising multiple wells coupled proximate the plasmon surface for containing fluid proximate portions of the plasmon surface where reflection of the light occurs.

21. The optical detector of claim 17 and further comprising a solution well between the electrode and plasmon surface for containing a fluid proximate a portion of the plasmon surface where reflection of the light occurs.

22. The optical detector of claim 20 wherein the charged molecules within the well migrate toward the plasmon surface in the presence of an electric field.

23. The optical detector of claim 21 wherein the well comprises a fluid aperture and an insulator creating a channel to the plasmon surface that is offset from the fluid aperture.

24. The optical detector of claim 21 wherein the well comprises a fluid aperture opening into a reservoir, a detection hole allowing charged molecules to move into a detection chamber proximate the plasmon surface.
